(19) United States
(12) Patent Application Publication
(10) Pub. No.: US 2012/0030091 A1
(43) Pub. Date: Feb. 2, 2012

(54) Credit Risk Control

(75) Inventors: Xiaoming Hu, Hangzhou (CN); Jing Gao, Hangzhou (CN); Feng Li, Hangzhou (CN); Weiyan Lv, Hangzhou (CN); Xiuyun Zhang, Hangzhou (CN); Zhengwei Zhang, Hangzhou (CN)

(73) Assignee: ALIBABA GROUP HOLDING LIMITED, Grand Cayman (KY)

(21) Appl. No.: 12/600,978

(22) PCT Filed: Aug. 19, 2009
(86) PCT No.: PCT/US2009/054323

§ 371 Date: Nov. 19, 2009

(30) Foreign Application Priority Data
Aug. 19, 2008 (CN) 200810147480.9

(51) Int. Cl. G06Q 40/00

(52) U.S. Cl. 705/38

(57) ABSTRACT

A method and a system of credit risk control use different incentive mechanisms for different type of users for post-loan credit risk control. The method classifies the user to one of several different user types based on the user information and a correspondence relationship between the user information and risk levels, and selects an appropriate incentive mechanism for risk control based on the user type. The incentive mechanisms may either be a positive incentive mechanism or a negative incentive mechanism depending on the user type. The incentive mechanisms are performed over a network, and are designed to encourage a user of good loan payment record but to discourage a user of bad loan payment record. The method and the system are particularly suited for risk control of repayment of various kinds of loans which are applied and disbursed over the Internet.

### RELATED APPLICATIONS

This application is a national stage application of international patent application PCT/US09/54323 filed Aug. 19, 2009, entitled “CREDIT RISK CONTROL”, claiming priority from Chinese patent application, Application No. 200810147480.9, filed Aug. 19, 2008, entitled “METHOD AND SYSTEM OF CREDIT RISK CONTROL”, which applications are hereby incorporated in their entirety by reference.

### TECHNICAL FIELD

The present disclosure relates to the field of electronic commerce, and particularly relates to methods and systems of credit risk control.

### BACKGROUND

Along with rapid economic developments all over the world, there is a growing need for a company or an individual to apply a loan from a bank or a financial institution. For example, a company may need to introduce advanced technologies and equipment in order to expand production scales. These technologies and equipment generally require a large amount of capital, very often beyond tens of millions of dollars. An individual user may need several hundred thousand dollars or more to start up a company or purchase a home. For these companies and individuals, it may be difficult to come up with such a huge amount of money, and therefore have to resort to borrowing a loan from a bank as the solution. In a loan process, the company or the individual applies for a loan from a bank. Upon verification of the identity and qualifications of the company or the individual by the bank, a loan agreement is signed, and the loan is disbursed.

Under the existing methods, the bank has scarce sources for obtaining information related to loan's after the loan has been given. The bank may be unable to timely conduct update, timely notify a related person or an institution, and timely initiate a risk control process. These conditions result in poor credit risk control. For example, because the bank often fails to timely obtain information such as loan utilization condition, whether the use of the loan satisfies a loan agreement, whether payments have been highly made, and whether any bad records of the borrower have occurred, the bank may not be able to recover principal and interests at the end of the loan period, resulting in a bad loan.

More specifically, following deficiencies in existing technologies have been observed. After a borrower has successfully obtained a loan, the bank has limited risk control over the loan, and lacks an effective channel or means to promptly and extensively expose the borrower who fails to repay the loan. Overdue payment and default payment frequently occur either due to the borrower's inability to pay or even unwillingness to pay. Furthermore, the bank usually does not reward good loan payment behavior, and lacks a concrete and quantized evaluation system and method for evaluating and handle such repayment behavior. As a result, whether a loan is repaid earlier or late does not make much difference once the borrower has obtained the loan.

### SUMMARY OF THE DISCLOSURE

Disclosed are a method and a system of credit risk control using different incentive mechanisms for different type of users for post-loan credit risk control. The method classifies the user to one of several different user types based on the user information and a correspondence relationship between the user information and risk levels, and selects an appropriate incentive mechanism for risk control based on the user type. The incentive mechanisms may be a positive incentive mechanism, a negative incentive mechanism, or a modified incentive mechanism, depending on the user type. The incentive mechanisms are performed over a network, and are designed to encourage a user of good loan payment record but to discourage a user of bad loan payment record. The method and the system are particularly suited for risk control of repayment of various kinds of loans which are applied and disbursed over the Internet.

In one embodiment, the user types include a first user type, a second user type, a third user type, and a fourth user type each associated with a different risk level. The first user type is characterized by a good loan payment status, the second user type by an approaching loan payment due date, the third user type by a loan payment that is overdue, and the fourth user type by a loan payment made within a specified time after a bad loan status warning has been issued. Accordingly, a positive incentive mechanism may be selected for the first user type, a negative incentive mechanism may be selected for one or more of the second user type and the third user type, and a modified incentive mechanism may be selected for the fourth user type.

In one embodiment, the positive incentive mechanism increases a credibility index of the user based on user information, and sends the credibility index to an associated website and an associated bank system. The negative incentive mechanism promulgates a public warning against the user over the Internet. The negative incentive mechanism may also send a reminder to the user to repay a loan, and send warnings other users that may be related to the current user who has a bad loan record.

The negative incentive mechanism may also instruct a website holding a user's financial account to close the financial account of the user. The negative incentive mechanism may send a bad loan record of the user to the website, and further make the bad loan record of the user available for search by search engines.

Where the user is the fourth type user (i.e., the user has made a loan payment within a specified time after a bad loan status warning has been issued), a modified incentive mechanism may withdraw an existing public warning of the user. The withdrawing mechanism may delete a bad record of the user from an associated website, and promulgate an announcement of withdrawing a public warning of the user.

To obtain the user information of the user, the credit risk control system may automatically synchronize the user information held at the credit risk control system with the user information held at an associated website or a financial system.

The disclosed system of credit risk control includes a computer having a computer processor and a data storage. The computer processor is programmed to perform the method of credit risk control described herein. The computer may be a server computer connected to the Internet. The user information and the correspondence relationship may be stored in the data storage of the system.

The disclosed method and system are particularly suited for risk control of repayment of various kinds of loans which are applied and disbursed through the Internet. The method benefits from Internet technologies to effectively control loan risk and cost, and helps to promote a loan product. The method and system may potentially reduce the number of bad loans, and encourage normal loan repayment of the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF DRAWINGS

The detailed description is described with reference to the accompanying figures. In the figures, the use of the same reference numbers in different figures indicates similar or identical items.

FIG. 1 shows a flow chart illustrating an exemplary method of credit risk control in accordance with the present disclosure.

FIG. 2 shows a structural diagram illustrating an exemplary credit risk control system in accordance with the present disclosure.

FIG. 3 shows a schematic structural diagram of the credit risk control system in an exemplary environment.

### DETAILED DESCRIPTION

In order to more clearly understand technical schemes of the present disclosure in view of the existing technologies, the exemplary embodiments are described using the accompanying figures. The following description constitutes only a few exemplary embodiments of the present disclosure.

By providing a method and a system of credit risk control, the present disclosure deals with the problem of risk control of repayment of various kinds of loans. The method and the system are particularly suited for loans which are applied for and disbursed through the Internet. A user who obtains and regularly repays a loan is rewarded and encouraged, and the reputation of the user is improved to make it easier for the user to obtain a loan again. Through issuing negative public notice or warning of a user who fails to repay a loan, the system makes it harder for the user to apply and obtain a loan again. The system of credit risk control minimizes the probability of having a bad loan, and encourages normal loan repayment of a user from the above two aspects. The system takes full advantage of the power of the Internet technologies to effectively control the loan risk and cost. This helps promote loan products.

Positive incentive mechanism refers to rewarding a loan borrowing company or individual which honors the loan agreement by various means such as increasing online credit (e-commerce). The positive incentive mechanism is designed to encourage the loan borrowing company to repay a loan, and improve the rate of loan repayment.

Negative incentive mechanism refers to punishing a loan borrowing company or individual which fails to timely pay back principal and interests of the loan according to the loan agreement. A negative is end of mechanism may use various means such as sending out a reminder and issuing a warning on the Internet in order to press the loan borrowing company to repay the loan timely. The reminder and the warning may be private or within the limited circle with a mild measure, but can be escalated to public warnings such as a “wanted” order openly spread over the Internet. The negative incentive mechanism is designed to increase the awareness the loan borrowing company's need of repaying the loan and improve the rate of loan repayment.

In one embodiment, a user has applied and obtained for a certain loan product through various channels or methods such as an online method or an offline method. Through association with various loan application systems, a credit risk control system obtains detailed information of the user, which includes user information such as the name of the borrower, the legal entity of the company, the loan applicant, the time of application, the type of the loan, the bank which issues the loan product, and the loan amount. The credit risk control system creates a user database record using the above information.

Through communications with the loan evaluation and lending systems of banks and credit institutions, the credit risk control system updates the loan information of the user, which may include the start date of the loan term, the end date of the loan term, the line of credit, the record of disbursement, the start date of single disbursement, the end date of single disbursement, the amount of single disbursement, and other information such as delinquency and delinquent amount. Based on the above-described information, the credit risk control system takes a role of supervising, monitoring, or even actively collecting the payments of the loan from the user to make sure that the loan is paid off before a due date of the loan. The primary targets of this procedure include the current borrower and other core users associated the current borrower. The system may maintain an online honor roll, updates the loan profile of the borrower and use it as references for deciding whether to raise credit score or ranking of the borrower and whether to increase the allowable loan amount by banks in a next loan application of the borrower. At the same time, the information such as the records of loan repayment and bank's comment is added to the user's file kept by online and offline credit institutions. The system may elevate the measure of monitoring and collection when a user fails to timely repay a loan. The targets of this process may include the current borrower, the core users associated with the current borrower, and the primary business partners.

For example, a warning may be issued on a website for a borrower having a bad loan. The related web page is publicly promulgated through search engines. Each borrower with a bad loan may be given an individual detailed web page with contents including the information of the borrower (an individual or a company), information of the loan owed, and the information of the owners of the company borrower. All users related to the borrower who has a bad loan, such as business partners, users of the same business type, and users within the same geographical region, maybe actively informed of the bad loan status of the borrower. The borrower's files in each associated system and website are updated by adding a record of loan repayment failure. The borrower's related accounts and privileges may be closed.

Finally, through connections with the loan evaluation and lending systems of the banks and the credit institutions, the credit risk control system provides feedback information such as past loan applications and loan repayments of the borrower to various related banks and credit institutions to allow a borrower who has a good record of loan borrowing and repayment to more easily obtain another loan, and make it more difficult for a borrower having a bad loan record to apply an additional loan product from the banks.

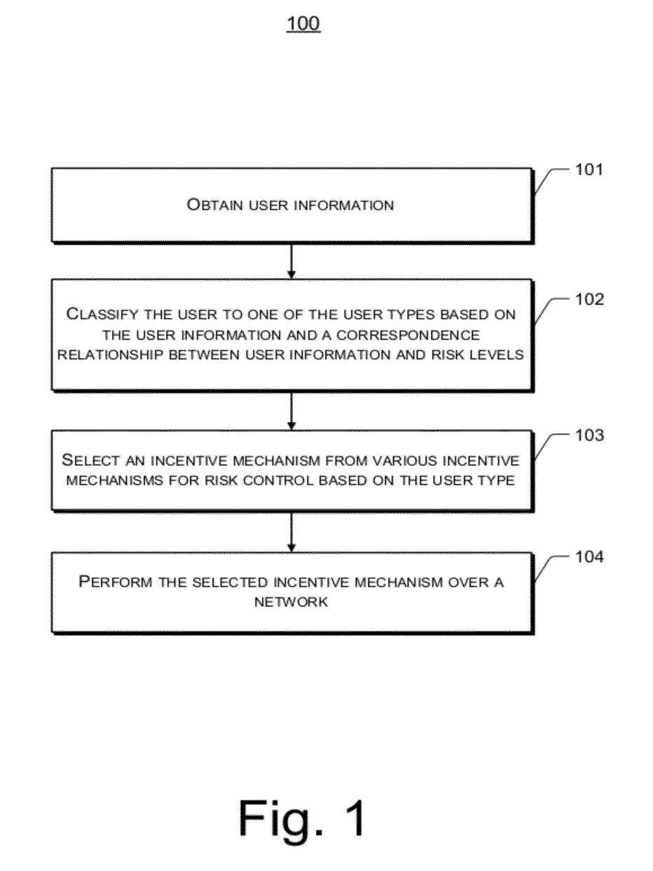

FIG. 1 shows an exemplary process 100 of credit risk control in accordance with the present disclosure. In this description, the order in which a process is described is not intended to be construed as a limitation, and any number of the described process blocks may be combined in any order to implement the method, or an alternate method. The process 100 is described as follows.

At Block 101, the credit risk control system obtains information of a user (a borrower) from loan application systems, bank systems, and credit institution systems. The credit risk control system may obtain detailed information of the user through association with various loan application systems. In the present disclosure, the information of the user or the user information may include not only personal information or general company information of the borrower, but also the information of the loan taken by the borrower. Examples of such user information include the time of loan application, the legal entity of a borrowing company, the identity of the applicant, the type of loan, the bank to which the loan product belongs, and the loan amount.

The credit risk control system updates the loan information of the user through communications with the loan evaluation and lending assistance of banks and credit institutions. Such updates may be conducted regularly or set to occur automatically.

During information acquisition, the credit risk control system connects with other systems through a public network or a designated line using Internet protocols such as http, https and Socke for transmission, and sends data in a suitable format such as xml, and html. The information of a user who applies for a loan online may be automatically sent to the credit risk control system. Moreover, the credit risk control system may regularly initiate system tasks to conduct information update with the bank systems.

The data of a loan applied through an off-line channel may be transmitted to the credit risk control system using alternative methods. For example, the information may be sent to the credit risk control system by an operating platform or software of the application channel. The off-line information may also be recorded into the credit risk control system using various data entry methods such as manual entry and scanning.

At Block 102, the credit risk control system classifies the user based on the information of the user and a correspondence relationship between the user information and risk levels. All users are classified using a system of multiple classes based on collected user information described above. For example, all the users may be classified under four classifications including a first user type, a second user type, a third user type, and a fourth user type. The first user type corresponds to a low risk level and refers to a user having a good loan record. This type includes users who timely pay off the loan and users who not only pay off the loan but also help another borrower pay a certain amount of that borrower's loan. The second user type corresponds to a medium risk level and refers to users who have an approaching due date for making a loan payment. The third user type corresponds to a high risk level and refers to users who have a loan that is overdue. The fourth user type corresponds to a mitigated risk level and refers to users who have made repayment to the loan after a public warning has been issued. Correspondence relationships between classifications and risk levels may be adjusted at a back-end of the system. For example, a user type may be adjusted to correspond to a different risk level, and a new user type may be created to correspond to a certain newly defined risk level, etc.

At Block 103, the system selects a relevant incentive mechanism for risk control based on a classification result of the user. For example, a positive incentive mechanism is selected for a user of the first user type which corresponds to low risk level. A negative incentive mechanism is selected for a user of the second, the third, or the fourth user types, which correspond to medium risk level, high risk level, and mitigated risk level respectively.

At block 104, the system performs the selected incentive mechanism over a network, such as the Internet.

An exemplary way for applying a positive incentive mechanism of the credit risk control system can be through online banking (i.e., electronic commerce) using scoring rules, described as follows.

### (1) OVERVIEW

For a company that has just obtained a loan or a company that is paying an existing loan, credit conditions of the company can be improved by increasing its respective score with an available credit score system, such as TrustPass indices, to encourage better loan repayment.

### (2) SCORING RULES

In one embodiment, an index increase is only applied for a company which applies and obtains a loan through the Internet or an electronic commerce. Existing loans that support the Internet and the electronic commerce's application standard include online joint guarantee loans, pure credit (unsecured) loans, Quick Finance loans, and chain loans, etc.

For a company which has successfully obtained a loan, its index is increased by a certain number of points, e.g. five points, regardless of the loan amount. For a company which repays its own loan, index is increased by the same amount whether the loan is an online joint guarantee loan, unsecured loan, chain loan, or Quick Finance loan. For a company which repays an online joint guarantee loan on behalf of another joint company, its index is increased by twice the repayment score of a company which repays its own loan. Prerequisite requirements for raising an index of a company among companies of an online joint guarantee loan may be sent. An exemplary requirement is that all joint companies have paid off their loans.

For a company which receives help from another company for repaying a loan, corresponding index is not increased.

Scoring rules for credibility index (e.g., TrustPass indices) may use a rounding rule. A cap and a bottom may be used to maintain the maximum score and a minimum score of the index score of a repaying company within a one year period. An existing index score may change as maximum allowable loan amount increases.

### (3) SCORING MECHANISM

The credit risk control system may actively or passively receive feedbacks from the banks user records of disbursement and repayment, with an identifier indicating whether each record refers to disbursement or repayment.

The credit risk control system checks the status of several indicators such as the due date in a repayment record, whether identifier indicates a repayment, whether corresponding loan has been paid off, and whether the balance loan amount matches the line of credit (this criterion may not be used in determination of the last disbursement), and applies a matching scoring rule based on the loan product information of the user. The system may read the primary information of a loan which includes loan amount limit, due date, company information, and company remarks.

After the scoring, the system generates a scoring result in form of a unique and persistent XML message for display by the front-end. The system then sends the scoring result to the associated websites, the associated bank systems, and the associated credit institution systems as a reference used by the banks and the credit institutions next time when the user applies for a loan. Scoring data is transmitted in a proper format, such as xml or html, to the associated websites, the associated bank systems, and the associated credit institution systems using an Internet protocol such as http, https, or Socke.

For Example, Suppose a User has a Repayment Record as Follows:

due date: after today's date;

whether the identifier indicates a repayment: yes;

whether the loan has been paid off: yes;

whether the loan amount matches the line of credit: yes.

The user is then determined to be a first user type (i.e., a user having a good loan record and corresponding to a low risk level). The credit risk control system starts a positive incentive procedure. Based on the predetermined scoring rule, the credit risk control system adds five points to the user through the back-end, and then sends the updated score to associated websites the associated bank systems and the associated credit institution systems that are related to the user.

### (4) EXAMPLES FOR ILLUSTRATION

Assume the maximum limits for online joint guarantee loan, unsecured credit loan and chain loan are, respectively, two million dollars, one million dollars, and ten million dollars. Two alternative scores are illustrated below.

Score 1: A loan repaying company receives one point for each loan repayment of fifty thousand dollars, and receives two points each time when it helps another company pay fifty thousand dollars of the other company's loan, with a cap of two hundred points and a minimum score of ten points.

Score 2: A loan repaying company receives one point for each loan repayment of twenty thousand dollars, and receives two points each time when it helps another company pay twenty thousand dollars of the other company's loan, with a cap of three hundred points and a minimum score of ten points.

TABLE 1 shows exemplary scoring rules of an exemplary credit Index (TrustPass index) of an existing online joint guarantee company.

TABLE 1
Scoring rules

| | Amount (in | | | Amount (in | |
|---|---|---|---|---|---|
| | Ten | | | Ten | |
| Status | Thousand) | Score 1 | Status | Thousand) | Score 2 |
| Obtain a loan | Any | 5 | Obtain a loan | Any | 5 |
| successfully | | | successfully | | |
| Repay a loan | 0.1 | 1 | Repay a loan | 0.1 | 1 |
| on its own | 4.9 | 1 | on its own | 4.9 | 1 |
| | 49.9 | 10 | | 19.9 | 10 |
| | 50 | 10 | | 20 | 10 |
| | 200 | 40 | | 200 | 100 |
| Help another | 0.1 | 1 | Help another | 0.1 | 1 |
| paying a loan | 2.5 | 1 | paying a loan | 0.9 | 1 |
| | 2.6 | 2 | | 9.9 | 10 |
| | 4.9 | 2 | | 10 | 10 |
| | 25 | 10 | | 200 | 200 |
| | 200 | 80 | | 400 | 400 |
| | 400 | 160 | | 600 | 600 |
| | 600 | 240 | | | |
| Helped by | N/A | N/A | Helped by | N/A | N/A |
| another to pay | | | another to pay | | |
| a loan | | | a loan | | |
| Total | | 200 | Total | | 300 |

| | |
|---|---|
| Remarks | If maximum limit of a loan increases, the cap for a score increases as well. |

The negative incentive mechanism of the credit risk control system refers to a series of punitive measures adopted by the credit risk control system in view of behavior and outcome of failing to repay principal and interest of a loan by a company which has obtained the loan from a bank partner. A variety of negative measures may be applied, such as announcing a collecting process to collect payment, informing the consequence of agreement violation, online spoilers of companies which violate a loan agreement, and issuing public warnings on the Internet.

Examples of Such Measures are Described as Follows.

(1) Send a reminder via emailing and/or leaving a message before issuing a warning on the Internet. If the credit risk control system determines that a due date in a repayment record is after the today's date, the identifier indicates a repayment, the corresponding loan is not paid off, and the time to the due date (the due date minus today's date) is less than X days, where X is defined by the system (e.g., X equals ten days), the credit risk control system may decide that the user is a second type user. In other words, the user has an approaching due date on the loan, and therefore corresponds to a medium risk level. The credit risk control system selects and starts a reminding mechanism. For example, the system reminds the user (e.g., a the company borrower) by way of an email and/or a message left through instant messaging tools, to give the user a last opportunity to make the payment on the loan. The reminder message may specifically remind the loan borrowing user to pay the loan, and also remind online joint guarantee users associated with the loan borrowing user to repay the loan.

(2) Issue a warning on the Internet. By determining that a due date in a repayment record is before today's date, the identifier indicates a repayment, and the corresponding loan has been not paid off, the credit risk control system decides that the user is a third type user (i.e., a user having a loan that is past due and corresponding to a high risk level), and starts a mechanism of issuing a warning or a public notice on the Internet. Prior to issuing a warning or notice, an operator of the credit risk control system submits an application for a warning of the user in the credit risk control system. Upon approval at all necessary levels such as a supervisor, an operation manager, a test engineer, a quality engineer, or a product manager, the warning of the user is issued and becomes effective. Announcement of the warning is promulgated on the Internet after a probation period (e.g., twenty-four hours), prior to which the warning may be canceled at any time with authorization. If necessary, such warning may be given only after a grace period has elapsed. The warning may take a graduated form. It may start with a private warning, become a warning in the limited circle of related parties, and escalate to a public warning (such as a “wanted list” or blacklist) that is promulgated over the Internet.

Meanwhile, the credit risk control system may also submit an account closing instruction to the associated websites, to request that all accounts of the user held in the associated websites and systems be suspended or closed.

The loan borrowing user and online joint guarantee users associated with the loan borrowing user are further urged to repay the loan by way of emails and/or messages left through instant messaging tools. Moreover, the system informs the users of the same business type of the loan borrowing user and associated users that the loan borrowing user has a bad record of failing to repay a past due loan. The bad record of the loan borrowing user is sent to all associated websites, which may be instructed to announce the bad record from their system as well. The credit risk control system may further instruct all the associated websites to provide to Internet search engines links of the loan record information of the high-risk user. This makes the bad record of the loan borrowing user available for Internet searches.

The following describes an exemplary keyword binding rule of a search list which provides online search for bad records of loan borrowing companies having a loan past due.

(a) Use the blacklisted company names and the respective regions of the companies as fixed bound keywords.

(b) Bind keywords of a number of primary products (e.g., minimum of five) of each blocked company. The number of the bound products and the selection of the bound products may be flexible.

(c) If a common keyword exists among multiple companies, choose one or more companies that entered the blacklist most recently and place them into the search list. A chronological order of the blacklist may be used.

(d) Example: keywords for Hangzhou Socks Company A include Hangzhou Socks Company A, Hangzhou, silk stockings, quilted stockings, and long stockings; keywords for Wenzhou Socks Company B include Wenzhou Socks Company B, Wenzhou, silk stockings, lady's socks, and sports socks. If a keyword “Hangzhou” is searched, Company A will show up in the search. If “silk stockings” is searched, both companies will show up in the search. If “sports socks” is searched, Company B will show up in the search.

Withdrawing a Warning:

A previously issued warning may be withdrawn if the payment condition of the user has changed. For example, by determining that a due date in a repayment record is prior to today's date, identifier indicates a repayment, corresponding loan has been paid off, and the due date is less than X days before today's date, where X is defined by the system (e.g., X equals one hundred and eighty days), the credit risk control system decides that the user is a fourth type user. That is, the user has made a repayment to the loan within a specific time after being warned publicly and thus corresponds to a mitigated risk level. The system may start a procedure of withdrawing the warning that has been previously issued. An operator in the system submits an application for withdrawing a warning of the user. Upon approval by all necessary levels of authority, the system takes the warning offline.

To take a warning off-line, the credit risk control system may first send an instruction to all the associated websites to announce a cancellation of the warning of the loan borrowing user on the associated websites, and to request deletion of the relevant records. The system may also request that the accounts of the loan borrowing user on the associated websites and systems be restored.

TABLE 2 is a description of exemplary rules for incentive mechanisms of credit risk control.

TABLE 2
Rule description

| Key Rule Item | Detailed Rule Description |
|---|---|
| Pre-warning of publicity - TradeLink application | TradeLink application in the company's account |
| of the defaulting company (borrower) shows a | shows a pop-up message once a day prior before a |
| pop-up message | public warning of the user is released |
| Pre-warning of publicity - Display the homepage | AliHelp in the company's account is displayed at |
| of AliHelp | each login prior to a public warning of the user is |
| | released |
| Pre-warning of publicity - Use direct messaging | Send a direct message to the company once a day |
| to communicate | before a public warning of the user is released. |
| TrustPass Record - Display Bank Loan Record, | Bank loan record of the company is displayed |
| Bank Comment | upon successful loan application, timely loan |
| | repayment, or helping another company to repay a |
| | loan. Contents to be displayed include: date, |
| | bank, amount, and names of joint companies. |
| | Contents of bank comment to be displayed |
| | include: bank, and content of comment. For |
| | example, China Construction Bank may issue the |
| | following remarks to be displayed: “This |
| | company has passed our preliminary review and a |
| | second review. The company's credibility is |
| | believed to be good.” |
| TrustPass Record - Increase TrustPass Index | With the company's approval, the system displays |
| | contents of an index increase which may include |
| | the score and reasons for the score increase. An |
| | exemplary content of display: financing condition - |
| | ten points; status of the financing verification by |
| | bank - passed. |
| Website Detail - Display markers of a user who | Upon loan repayment by the company, the |
| has obtained and repaid the loan successfully | webpage may display contents to mark the |
| | company's successful status. |
| Configuration File of Search List | Contents of a configuration file include: |
| | keywords, company names, legal representatives |
| | of entities, regions, debt amounts, payment due |
| | dates, reasons for blocking, URLs. |
| Search List of the publicly warned borrowers | If a user inputs a binding keyword for search, |
| (e.g., blocked companies) | information of a blocked company is displayed, |
| | which includes: company name, legal |
| | representative of the entity, region, debt amount, |
| | loan payment due dates, reasons for blocking, and |
| | linked URLs to for the information. The search |
| | may limit the maximum number of blocked |
| | companies that are displayed for each search, and |
| | the companies are listed in a search result |
| | according to the order of their blocking times. |
| Obtain IDs of business partners in the TradeLink | The system may obtain the IDs of all business |
| | partners in the TradeLink of a company at two |
| | various times if the company has not made the |
| | payment (e.g., ten days before the due date or past |
| | the due date). |
| Exclusion from business partners - TradeLink of | Business partners in TradeLink of a blocked |
| the business partners shows a pop-up message. | company are informed. TradeLink of the business |
| | partners shows a pop-up message within ten days |
| | after the account of the company is closed. |
| Exclusion from Business Buddies - direct | Business partners of a blocked company are |
| messaging | informed via emails within ten working days after |
| | the company has been blocked. |
| Cancellation of public warning - Announcement | Upon bank approval, cancellation of a public |
| | warning of a company is announced if the |
| | company makes the loan repayment within one |
| | month after being blocked. |
| Cancellation of public warning - Account | Upon bank approval, accounts of a company on e- |
| Recovery | commerce sites (e.g., Alibaba.com) are restored if |
| | the company makes the loan repayment within |
| | one month after being blocked. |

Benefits of Using an Incentive Mechanism

A positive incentive mechanism benefits a company which obtains a loan. Through advertising and rewarding a company which honors a loan agreement in multiple levels, the credit risk control system quantizes the company's repayment behavior and obtains a measurable score using the Internet through interaction among systems. The credit risk control system enhances the benefit of loan-fulfillment behavior. This helps a good behaving company leave good impressions on its potential customers and potential bank partners, and improves its reputation on the Internet. This creates additional business opportunities and opportunities for raising new capital to further affect other loan applying companies.

A positive incentive mechanism benefits a partner bank. The positive incentive mechanism of the credit risk control system aims to encourage loan repaying companies, positively affects loan borrowing companies, and improves the rate of loan repayment such that banks may timely receive the payments on principals and interests of the loans.

A positive incentive mechanism also benefits the Internet and electronic commerce in general. By translating measurable credibility and credit records of companies into qualifications and indicators of company's ability to fulfill an agreement, the credit risk control system is able to show various degrees of the credibility of business owners. This helps establish a credit system based on the Internet and electronic commerce, and a virtual circle of trusted merchants under a harmonious society, and improves competitive level and confidence level of electronic commerce companies.

The negative incentive mechanism also benefits various parties, as discussed below.

To a company which has violated its loan agreement, through a series of punitive measures, the loan borrowing company is alarmed. The negative measures elevate the consequences and cost due to a loan agreement violation, prompting a violating company to repay the loan eventually. The negative measures also have the effect of discouraging other loan borrowing companies that may be defaulting.

The negative incentive mechanism of the credit risk control system benefits the banks because it aims to prompt more companies to timely repay loans. Through a series of measures that threaten punishment, and actual punishment of a company which violates an agreement, the method improves the rate of loan repayment.

The negative incentive mechanism also benefits the Internet and e-commerce in general because it helps to establish a trustworthy financial environment. The virtual credibility index in particular helps to create a harmonious and credible atmosphere of online business.

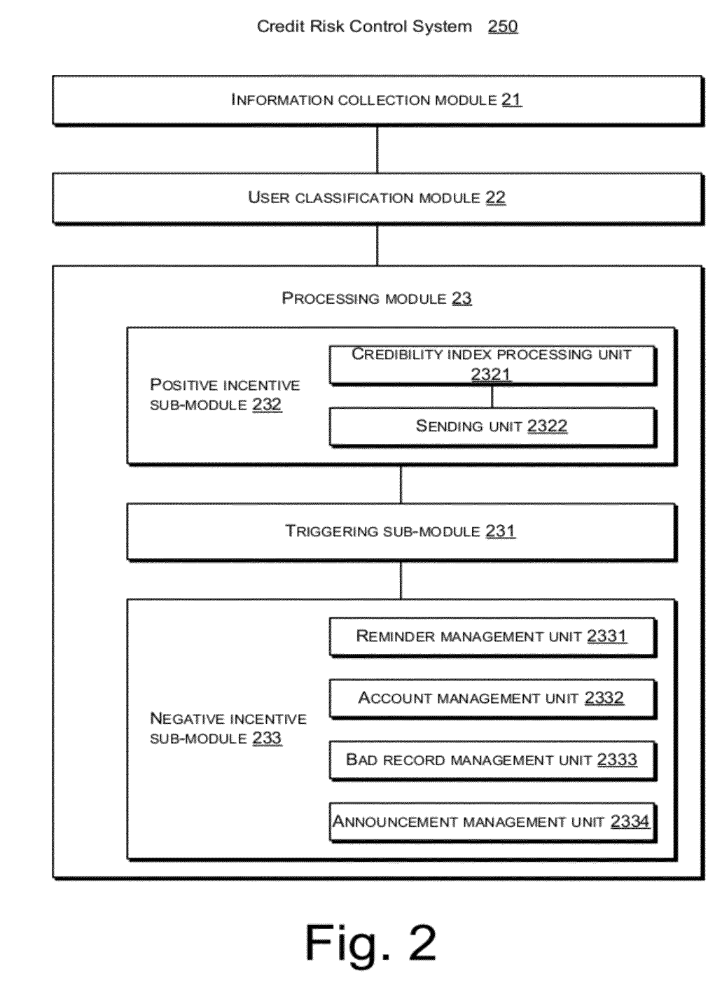

FIG. 2 shows an exemplary system 250 of credit risk control in accordance with the present disclosure. The credit risk control system 250 has various functional modules and the units. An information collection module 21 is used for collecting user information based on a user's identifier in a database. A user classification module 22 is used for classifying the user based on the user information collected by the information collection module 21 and a correspondence relationship between user information and risk level. A processing module 23 is used for starting an incentive mechanism for risk control based on a classification result of the user obtained by the user classification module 22.

The processing module 23 includes several sub-modules. A triggering sub-module 231 is used for starting a positive incentive sub-module 232 or a negative incentive sub-module 233 based on the classification result of the user. The positive incentive sub-module 232 is used for processing a first type user using a positive incentive mechanism. The negative incentive sub-module 233 is used for processing a second, a third, and a fourth type user using a negative incentive mechanism.

The positive incentive sub-module 232 further includes a credibility index processing unit 2321 used for increasing a credibility index of the first type user based on user information of the first type user; and a sending unit 2322 used for sending the credibility index obtained by the credibility index processing unit 2321 to an associated website and an associated bank system.

The negative incentive sub-module 233 also includes several sub-modules. A reminder management unit 2331 is used for reminding the second type user and the third type user to repay a loan, and for warning others of the third type user's bad record. The warning may be sent to a user of the same business type as the third type user and a user associated with the third type user.

An account management unit 2332 is used for closing accounts of the third type user in an associated website and an associated system, and for recovering accounts of the fourth type user in the associated website and the associated system. A bad record management unit 2333 is used for sending the bad record of the third type user to the associated website, for making the bad record of the third type user available for online six, and for deleting a bad record of the fourth type user from the associated website. An announcement management unit 2334 is used for promulgating an announcement of cancelling a warning of the fourth type user.

In the presence disclosure, a “module” or a “unit” in general refers to a functionality designed to perform a particular task or function. A module or a unit can be a piece of hardware, software, a plan or scheme, or a combination thereof, for effectuating a purpose associated with the particular task or function. In addition, delineation of separate units does not necessarily suggest that physically separate devices are used. Instead, the delineation may be only functional, not structural, and the functions of several units may be performed by a single combined device or component. When used in a computer-based system, regular computer components such as a processor, a storage and memory may be programmed to function as one or more units or devices to perform the various respective functions.

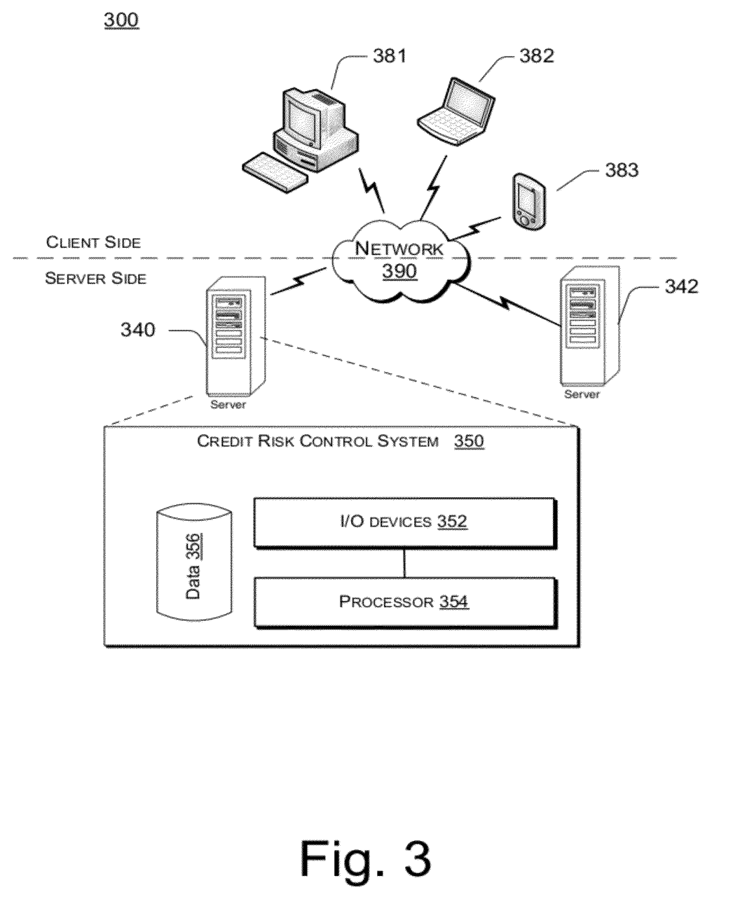

FIG. 3 shows a schematic structural diagram of the credit risk control system in an exemplary environment 300. Credit risk control system 350 is placed in exemplary environment 300 for implementing the method of the present disclosure. As illustrated in environment 300, some components reside on a client side and other components reside on a server side. However, these components may reside in multiple other locations. Furthermore, two or more of the illustrated components may combine to form a single component at a single location.

The credit risk control system 350 is implemented in a computer system 340 which is connected to client-side computing devices such as client terminals 381, 382 and 383, and external system 342 through network(s) 390. The external system 342 is a general representation of financial systems and website hosts which are in communication with the computer system 340 including the credit risk control system 350. Users (not shown) may access the credit risk control system 350 and the external system 342 through the client-side computing devices. In one embodiment, computer system 340 is a server, while client-side computing devices 381, 382 and 383 may each be a computer or a portable device, used as a user terminal. The server 340 may include common computer components such as processor(s) 354, I/O devices 352, computer readable media or data storage 356, and network interface (not shown).

The computer readable media 356 stores application program modules and data (such as data files user information and loan information). Application program modules contain instructions which, when executed by processor(s), cause the processor(s) to perform actions of a process described herein. It is appreciated that the computer readable media may be any of the suitable storage or memory devices for storing computer data. Such storage or memory devices include, but not limited to, hard disks, flash memory devices, optical data storages, and floppy disks. Furthermore, the computer readable media containing the computer-executable instructions may consist of component(s) in a local system or components distributed over a network of multiple remote systems. The data of the computer-executable instructions may either be delivered in a tangible physical memory device or transmitted electronically.

It is also appreciated that a computing system or device may be any device that has a processor, an I/O device and a memory (either an internal memory or an external memory), and is not limited to a personal computer. Especially, computer system 340 may be a server computer, or a cluster of such server computers, connected through network(s) 390, which may either be the Internet or an intranet. Especially, the computer device 340 may be a web server, or a cluster of such servers hosting a website such as an e-commerce site.

In one embodiment, credit risk control system 350 is configured to have various functional modules or units to perform the functions described herein with reference to FIG. 2.

The disclosed credit risk control system (250, 350) offers various benefits. For example, by connecting with loan evaluation and review systems of the banks in real time, the credit risk control system 350 may conduct timely risk control of a user having loan risk. The credit risk control system may also use the loan information of the user as an important indicator to evaluate a loan application. The credit risk until system may assist an external loan evaluation system, or act as a loan evaluation system by itself.

By connecting with bank systems (e.g., financial system 342) in real time, the credit risk control system 350 synchronizes all information of a loan borrowing user to ensure that all information of a user is available to a user end (e.g., user clients 381, 382 and 383). Online contents allow synchronization among merchant end, network service provider end, and bank end.

For a user who repays a loan normally, various aspects of contents such as the loan product used by the user, the loan amount, and the loan repayment information are translated into various types of application information such as online credibility, and information of associated websites. For a user who fails to repay a loan, credibility of the user is announced on websites which include, but are not limited to, the websites of network content providers and the websites of network service providers. When other users search for the user's related information, the bad record of loan repayment failure is displayed. Such exposure may result in exclusion of the user who fails to repay a loan from new business circles.

In addition, the system notifies users which are mostly likely to be in contact with the user who fails to repay a loan of the bad record. This circle of acquaintance users may be identified using basic information such as related addresses, business or industry friends and partners. Such the collection of the information of bad record may disrupt the business relationship between the user at fault and other users.

It is appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method of credit risk control, the method comprising:
providing a correspondence relationship between user information and risk levels;
obtaining the user information of a user;
classifying the user to one of a plurality of user types based on the user information and the correspondence relationship between the user information and risk levels;
selecting an incentive mechanism from a plurality of incentive mechanisms for risk control based on the user type, the plurality of incentive mechanisms including a positive incentive mechanism and a negative incentive mechanism; and
performing the selected incentive mechanism over a network.

2. The method as recited in claim 1, wherein the plurality of user types comprises a first user type, a second user type, a third user type, and a fourth user type each associated with a different risk level.

3. The method as recited in claim 2, wherein the first user type is characterized by a good loan payment status, the second user type is characterized by an approaching loan payment due date, the third user type is characterized by a loan payment that is overdue, and the fourth user type is characterized by a loan payment made within a specified time after a bad loan status warning has been issued.

4. The method as recited in claim 2, wherein selecting the incentive mechanism from the plurality of incentive mechanisms for risk control based on the user type comprises:
selecting the positive incentive mechanism for the first user type, and selecting the negative incentive mechanism for one or more of the second user type, the third user type and the fourth user type.

5. The method as recited in claim 1, wherein the positive incentive mechanism comprises:
increasing a credibility index of the user based on user information; and
sending the credibility index to an associated website and an associated bank system.

6. The method as recited in claim 1, wherein the negative incentive mechanism comprises:
promulgating a warning against the user over the network.

7. The method as recited in claim 1, wherein the negative incentive mechanism comprises:
sending a reminder to the present user to repay a loan.

8. The method as recited in claim 1, wherein the negative incentive mechanism comprises:
sending a notice to a related user to inform the related user that the present user has a bad loan record.

9. The method as recited in claim 1, wherein the user holds a financial account with a website, and wherein the negative incentive mechanism comprises:
instructing the website to close the financial account of the user held therein;
sending a bad loan record of the user to the website; and
making the bad loan record of the user available for search by search engines.

10. The method as recited in claim 1, wherein the plurality of incentive mechanisms further comprises a withdrawing mechanism including:
withdrawing an existing public warning of the user.

11. The method as recited in claim 1, wherein the plurality of incentive mechanisms further comprises a withdrawing mechanism including:
deleting a bad record of the user from an associated website; and
promulgating an announcement of withdrawing a public warning of the user.

12. The method as recited in claim 1, wherein obtaining the user information of the user comprises automatically synchronizing the user information held at a credit risk control system with the user information held at an associated website or a financial system.

13. A system of credit risk control, the system comprising a computer having a computer processor and a data storage, the computer processor being programmed to perform the following:
providing a correspondence relationship between user information and risk levels;
obtaining the user information of a user;
classifying the user to one of a plurality of user types based on the user information and the correspondence relationship between the user information and risk levels;
selecting an incentive mechanism from a plurality of incentive mechanisms for risk control based on the user type, the plurality of incentive mechanisms including a positive incentive mechanism and a negative incentive mechanism; and
performing the selected incentive mechanism over a network.

14. The system as recited in claim 13, wherein the computer is a server computer connected to the Internet.

15. The system as recited in claim 13, wherein the user information and the correspondence relationship are stored in the data storage of the system.
